(19) United States
(12) Patent Application Publication
(10) Pub. No.: US 2025/0030327 A1
(43) Pub. Date: Jan. 23, 2025

(54) LINEAR MOTOR

(71) Applicants: Houng Joong KIM, Incheon (KR); KOVERY CO., LTD., Hwaseong-si (KR)

(72) Inventor: Houng Joong KIM, Incheon (KR)

(73) Assignees: Houng Joong KIM, Incheon (KR); KOVERY CO., LTD., Hwaseong-si, Gyeonggi-do (KR)

(21) Appl. No.: 18/778,034

(22) Filed: Jul. 19, 2024

(30) Foreign Application Priority Data
Jul. 21, 2023 (KR) 10-2023-0095366
Jul. 5, 2024 (KR) 10-2024-0088623

(51) Int. Cl. H02K 41/02; H02K 3/18

(52) U.S. Cl. CPC H02K 41/02; H02K 3/18

(57) ABSTRACT

A linear motor may comprise a first member including a plurality of amature modules; and a second member including a permanent magnet module that includes a plurality of permanent magnets, of which the poles are alternated in a first direction along which the plurality of amature modules are arranged, wherein each armature module includes a magnet core including a connection part, and two or more salient poles protruding from the connection part, and a coil carrying a current of the same phase and wound around the magnetic core; wherein the permanent magnet module is disposed between two salient poles of the amature module; and wherein a distance between two neighboring armature modules is larger than a distance between two neighboring salient poles within the same amateur module.

### TECHNICAL FIELD

The present disclosure relates to a linear motor.

### BACKGROUND

In general, a linear motor has a structure that generates a thrust between a mover and a stator that face each other in a straight line. A permanent magnet type linear motor is constructed in such a manner that a fixed magnet is arranged at one of a mover and a stator and alternating multi-phase power is applied to the other, generating an electromagnetic force between the motor and the stator to produce a thrust in a predetermined direction.

Most conventional linear motors have a structure in which magnetic flux from the salient pole of the armature core passes through the permanent magnet and the yoke to form a magnetic closed circuit and to generate attractive and repulsive forces producing a thrust; therefore, in most cases, the permanent magnet is placed between the salient pole and yoke and attached to the yoke.

The inventor of the present disclosure disclosed a linear motor with a new structure filed under the application No. KR 10-2010-0081522, where the linear motor comprises a first member with a plurality of amature modules arranged in a row along a moving direction and a second member with one or more permanent magnet modules that include a plurality of permanent magnets, of which the poles are alternated in the moving direction.

If a significant amount of power is supplied to an electric motor to increase propulsion force and operating speed, substantial heat is generated in the armature module.

### SUMMARY

In view of the above, an object of the present disclosure is to provide a linear motor capable of dissipating the heat generated in the coil of an armature module.

A linear motor according to one embodiment of the present disclosure may comprise a first member including a plurality of amature modules; and a second member including a permanent magnet module that includes a plurality of permanent magnets, of which the poles are alternated in a first direction along which the plurality of amature modules are arranged, wherein one of the first member or the second member becomes a mover, and the other becomes a stator moving relative to each other in the first direction; wherein each armature module includes a magnet core including a connection part, and two or more salient poles protruding from the connection part, and a coil carrying a current of the same phase and wound around the magnetic core; wherein the permanent magnet module is disposed between two salient poles of the amature module; and wherein a distance between two neighboring armature modules is larger than a distance between two neighboring salient poles within the same amateur module.

By adopting a structure that facilitates smooth airflow between armature modules, the heat generated during high-thrust and high-speed operation of a linear motor may be effectively dissipated.

Also, the operating temperature of the armature module may be lowered by dissipating the heat generated in the coils of the armature module to the outside through a fan or a refrigerant conduit.

### BRIEF DESCRIPTION OF THE DRAWINGS

FIG. 1 illustrates an open-type linear motor disclosed in application No. KR 10-2010-0081522 filed by the inventor of the present disclosure.

FIG. 2 illustrates a linear motor in which nine armature modules constituting a first member are disposed in a distributed manner.

FIG. 3 is an exploded perspective view of a linear motor according to one embodiment.

FIG. 4 is a plan view of a first member constituting the linear motor of FIG. 3.

FIG. 5 is a plan view of a bobbin around which coils are wound.

FIG. 6 illustrates an exploded perspective view of a linear motor which secures a first member and an amature module base using a spacer.

FIG. 7 an embodiment in which a windshield protrudes toward a first member from the base of the linear motor of FIG. 6.

FIG. 8 illustrates an embodiment in which a conduit for refrigerant flow is installed between armature modules with wound coils.

### DETAILED DESCRIPTION

In what follows, preferred embodiments of a linear motor will be described in detail with reference to appended drawings.

The inventor of a linear motor, to which an embodiment of the present disclosure is applied, has filed a linear motor under the application No. KR 10-2010-0081522, where the linear motor comprises a first member including a plurality of amature modules disposed in a row along a moving direction and a second member including one or more permanent magnet modules that include a plurality of permanent magnets, of which the poles are alternated in the moving direction.

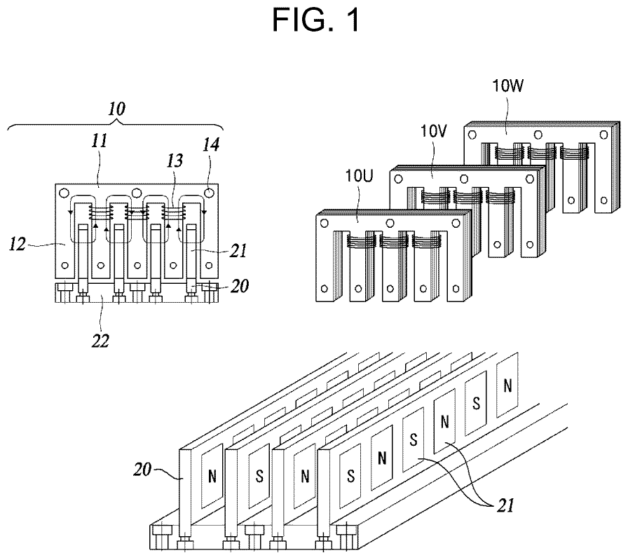

Among the linear motors disclosed in the application No. KR 10-2010-0081522, in the open-type linear motor as shown in FIG. 1, the connection part (or core) 11 of the armature module 10 does not adopt a C-shaped configuration that encloses a permanent magnet module, which is the second member, but has the form of a straight line; a plurality of salient poles 12 protrude from the connection part in the same direction, for example, at a right angle; and a plurality of permanent magnet modules 20 of the second member also have a shape that protrudes toward the connection part between adjacent salient poles arranged side by side.

Another linear motor disclosed under the application No. KR 10-2010-0081522 has different protrusion angles of the salient poles in the core of the armature module, which increases mold manufacturing costs and has limitations in improving precision. However, the linear motor of FIG. 1 has a fixed structure, in which all salient poles 12 in each armature module 10 form the same angle, for example, a right angle, with the connection part 11, and each permanent magnet module 20 also forms the same angle, for example, a right angle, with a permanent magnet base 22; therefore, manufacturing precision may be increased, and mold costs may be reduced.

The linear motor according to an embodiment of the present disclosure is a modification of the open-type linear motor of FIG. 1 into a permanent magnet driven-type from among the linear motors disclosed in the application No. KR 10-2010-0081522. The transport system employing a permanent magnet-driven linear motor enables long-distance transport by adjusting the interval between armature modules.

For example, the thrust for moving the permanent magnet 21 is proportional to the sum of surface areas of contact portions of the salient poles 12 and the permanent magnets 21; proportional to the number of armature modules 10 disposed in the moving direction; and proportional to the magnitude of current applied to the coils 13, the number of turns of the coils 13 wound around the salient poles 12, and the magnitude of the magnetic force of each permanent magnet 21.

A thrust is generated based on a combination of the number S of armature modules 10, which corresponds to a multiple of a motor constant M, and the number P of permanent magnets 21, which corresponds to a multiple of 2 (N pole and S pole). Here, the motor constant M is 3 if the armature is driven with 3-phase power and 5 if the armature is driven with 5-phase power; an odd-numbered motor constant equal to or greater than 3 is generally used, and a phase difference of a current applied to the coils of each armature module 10 is determined by the motor constant.

If the length (length in the moving direction) of a region in which the S armature modules face the P permanent magnets through an interval is referred to as a unit length of the first member, an effective distance capable of generating a thrust that moves the mover may be secured only when one of the first member composed of a plurality of armature modules 10 or the second member composed of a plurality of permanent magnets 21 is made to be longer than the unit length.

In other words, the effective distance for generating a thrust may be secured only when the length of the overlap portion of the first member and the second member is made to be longer than the unit length (the number of armature modules is equal to or greater than S or the number of permanent magnets is equal to or greater than P), and the magnitude of a thrust may be increased in proportion to the size of an interval formed between the overlapping first and second members.

The 3-phase current is applied to each amature module 10 of the first member along the moving direction in the order of UuU (or uUu) (U-phase group), VvV (or vVv) (V-phase group), and WwW (or wWw) (W-phase group), where lowercase letters indicate that a current of the opposite phase to the current denoted by the uppercase letters is supplied.

Supplying a current of opposite phase may mean supplying currents with a phase difference of 180 degrees to windings wound around different salient poles or supplying currents of the same phase to the windings but winding coils around the salient poles in opposite directions. In view of driving an electric motor, the latter is much more advantageous because it allows a current to be supplied through a single line while effectively supplying two currents with a 180-degree phase difference simultaneously.

The first member is configured as independent armature modules 10 without being connected to each other (a ferromagnetic body, which is the same material as a core of the first member); for this reason, if power having the same magnitude is provided to the respective armature modules 10, a magnetic flux independently flows through each armature module with the same magnitude, which results in less variation in the thrust produced by the armature modules 10 and thus reduces ripples in the thrust.

If the magnetic flux entering or existing the salient poles 12 is uniformly distributed, the magnetic flux passing through the salient poles 12 and the permanent magnets 21 is proportional to the area where the surfaces of salient poles 12 and permanent magnets 21 overlap.

The cross-section of the permanent magnet 21 through which a magnetic flux exiting or entering the salient pole 12 of the amature module 10 passes is not limited to a rectangular or parallelogram shape; the cross-section may have a rhombus, circle, or oval shape, as well as an octagon shape formed by cutting the four corners of a rectangle or parallelogram.

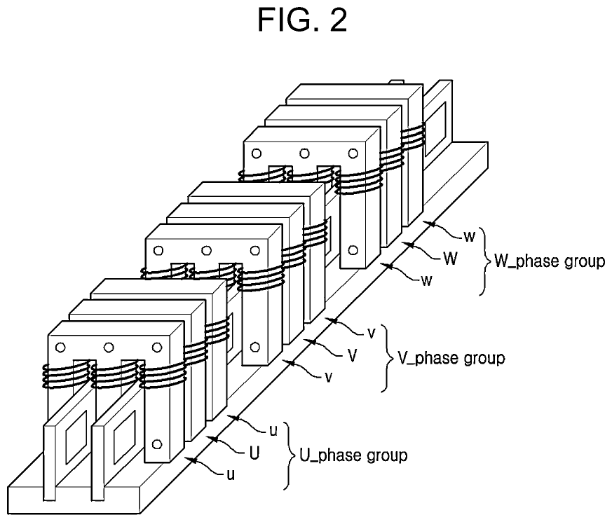

FIG. 2 illustrates a linear motor in which nine armature modules constituting a first member are disposed in a distributed manner, which illustrates a motor employing nine amature modules each with three salient poles based on the same principles applied to the linear motor of FIG. 1.

For example, in an electric motor with a basic unit of (S, P)=(9, 8), nine armature modules are disposed consecutively, and a 3-phase current may be applied in the order uUuvVvwWw (or UuUVvVWwW). To increase the symmetry efficiency of the magnetic circuit and the thrust in a linear motor, a large value is used for the number of the armature modules S in the basic unit of the motor, a value close to S is used for the number of permanent magnets P, and a plurality of basic units may be used by being connected to each other.

When a large number of armature modules are disposed consecutively for the first member, a significant amount of current may be supplied to the first member where the armature modules are densely packed, which may lead to deformation of the core or salient poles due to heat, reducing precision and causing cogging.

To solve problems due to thermal deformation and cogging and to increase precision, a plurality of armature modules may be disposed on the first member in a distributed manner, as shown in FIG. 2; at this time, amature modules supplied with currents of the same phase or 180 degrees out of phase (opposite phase) may be grouped together and separated from amature modules supplied with currents of other phases (e.g., 120 degrees phase).

In FIG. 2, for example, when driving an electric motor with a UVW 3-phase power source (where motor constant M corresponds to 3), the U-phase group supplied with currents of uUu phase, the V-phased group supplied with current of wWw phase, and the W-phased group supplied with currents of wWw phase are separated from each other and disposed in a distributed manner. The armature modules of the U-phased group, V-phased group, and W-phased group may be collectively referred to as an armature module group or an armature block.

When armature modules supplied with currents of the same phase are grouped together and disposed consecutively as an armature module group, coils of the armature modules belonging to the corresponding group may be connected to each other in series; in this case, since only one pair of wires is needed for the corresponding group, it is advantageous for assembling the first member and connecting the first member with a controller.

Since most linear motors other than the linear motor of the present disclosure have a structure in which the armature modules constituting the first member are connected directly to each other without separation, currents of different phases have to flow through neighboring armature modules. Therefore, for linear motors having different structures, it is not possible to dispose armature modules of the same phase consecutively as shown in FIG. 2.

The linear motor described with reference to FIGS. 1 and 2 generates a linear motion by arranging a plurality of armature modules side by side along a straight line and employing a permanent magnet module in which a plurality of permanent magnets are arranged in a straight line.

Meanwhile, when a large amount of current flows through the coil at high frequency to increase the driving force or operation speed of the linear motor to which the present disclosure is applied, significant heat may be generated in the first member in which a plurality of amature modules with a plurality of protruding salient poles around which coils are wound are arranged in a moving direction.

The present disclosure provides a structure of the first member that allows air to flow smoothly between armature modules to cool the heat generated in the coil wound around salient poles of the armature module.

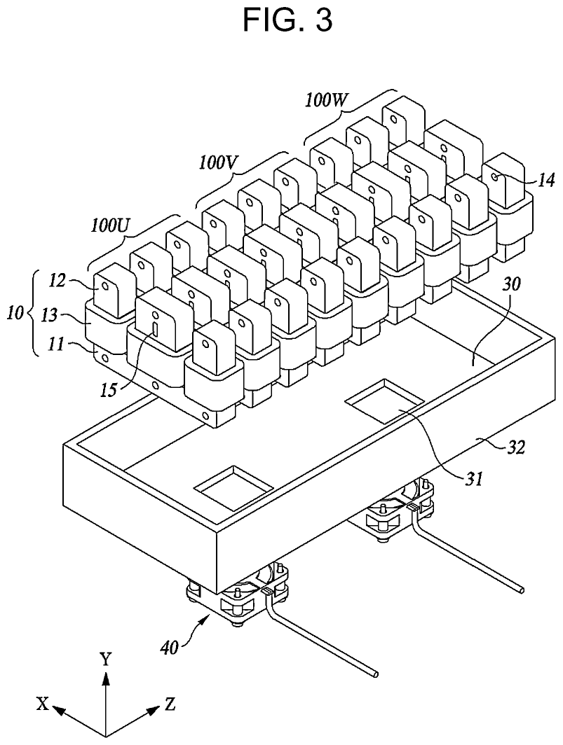

FIG. 3 is an exploded perspective view of a linear motor according to one embodiment. In FIG. 3, the second member consisting of a plurality of permanent magnet modules is omitted.

The linear motor of FIG. 3 may comprise a first member including a plurality of armature modules 10 arranged along a first direction (Z direction in FIG. 3), which is a moving direction, an armature module base 30 for seating the plurality of armature modules 10 of the first member, and a fan 40 mounted on the armature module base 30.

Each armature module 10 may comprise a connection part 11 formed of a magnetic core, a plurality of salient poles 12, and coils 13 wound around the salient poles 12.

The plurality of protruding poles 12 arranged in a second direction (X direction in FIG. 3) protrude from the connection part 11 in a third direction (Y direction in FIG. 3).

The coil 13 may be wound around a portion of the salient pole 12 close to the connection part 11.

One coil 13 carrying a current of the same phase may be wound in one armature module 10, and the winding directions of the coil 13 are different between neighboring salient poles 12.

As shown in FIG. 3, armature modules 10 wound with coils 13 carrying currents of the same or opposite phase may be grouped together and disposed adjacent to each other. In other words, armature modules 10 supplied with currents of the same (or opposite) phase may be grouped together and disposed adjacent to each other and separated from armature modules 10 supplied with currents of a different phase (e.g., 120 degrees phase).

A group of armature modules supplied with currents of the same (or opposite) phase may be referred to as an armature block. In FIG. 3, a U-phased armature block 100U, a V-phased armature block 100V, and a W-phased armature block 100W are arranged sequentially.

The interval between neighboring armature modules 10 within the armature block 100 may be constant. The interval between armature blocks 100 may be different from the interval between armature modules 10 within the armature module 100.

A first through hole 14 may be formed in the end part and connection part 11 of each salient pole 12 of the armature module 10 in the first direction. By passing a rod (not shown) through the through hole formed in a spacer (not shown) disposed between the armature modules 10 and the first through hole 14, the positions or interval of the plurality of armature modules 10 may be fixed based on the first direction.

A second through hole 15 in the first direction may be formed in at least one salient pole 12 of the armature module 10. The second through hole 15 may be formed in the end part of the salient pole 12, where the coil 13 is not wound, allowing the second through hole 15 to be exposed to the outside. When assembling a plurality of armature modules 10, the second through hole 15 is exposed without passing a rod through it, thereby allowing air to flow through the second through hole 15 and cooling the heat generated in the coil 13 of the armature module 10.

The second through hole 15 may have a larger cross-section than the first through hole 14. Also, the second through hole 15 may be formed in the central salient pole 10, which has a larger width in the second direction, as shown in FIG. 3.

A base groove 31 is formed in the armature module base 30 on which the first member is seated, allowing the fan 40 to be seated thereon.

Also, the armature module base 30 may include a windshield (or wall) 32 that protrudes in a direction toward the first member including the plurality of armature modules 10.

In FIG. 3, two windshields 32 are formed in each of the first direction (Z direction) and the second direction (X direction), but two windshields 32 may be formed only in the first direction (Z direction).

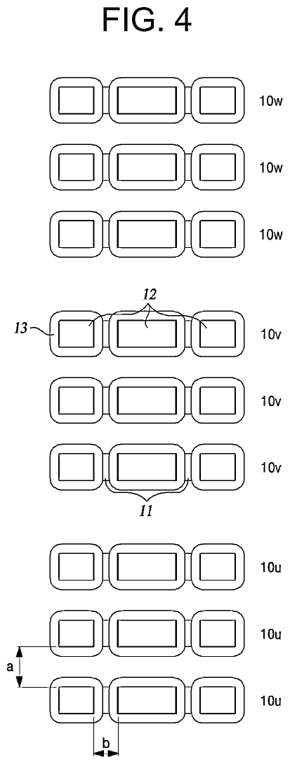

FIG. 4 is a plan view of a first member constituting the linear motor of FIG. 3.

The armature module 10 may be designed to prevent the coils 13 wound around neighboring salient poles 12 from coming into contact with each other and to provide a passage for air to flow smoothly between the armature modules 10.

For this purpose, the interval a between neighboring armature modules 10 and the interval b between neighboring salient poles 12 within the same armature module 10 may be formed to be large.

Alternatively, the interval a between neighboring armature modules 10 may be formed to be larger than the interval b between neighboring salient poles 12 within the same armature module 10.

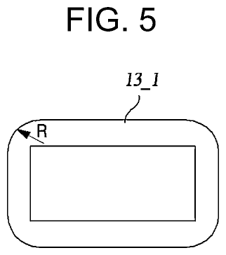

FIG. 5 is a plan view of a bobbin around which coils are wound.

The coil 13 may be wound around the bobbin 13_1 and then inserted into the salient pole 12. At this time, the corners of the bobbin 13_1, which guides the winding of the coil 13, may be rounded R to match the outer shape of the winding of the coil 13, thereby minimizing obstruction to air flow by the bobbin 13_1.

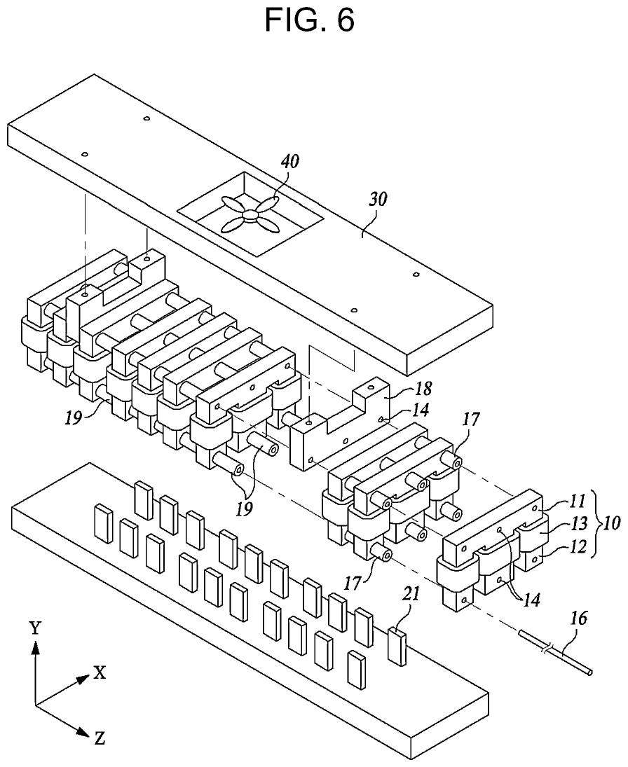

FIG. 6 illustrates an exploded perspective view of a linear motor which secures a first member and an amature module base using a spacer.

In FIG. 6, the fan 40 is mounted on the armature module base 30, but the windshield 32 is not formed thereon.

The interval between the armature module 10 within the armature block in which the currents of the same phase flow and a neighboring armature module 10 may be kept constant by the first 17 and second 18 spacers, not only at the connection part 11 but also at the end part of the salient pole 12.

The armature block and its neighboring armature block may maintain the interval between armature modules 10 facing each other in two neighboring armature blocks by the third spacer 19.

Although the first and second spacers 17 and 18 have the same length in the first direction, the first spacer 17 (or second spacer 18) and the third spacer 19 may have different lengths in the first direction.

A through hole is formed in the first, second, and third spacers 17, 18, 19 through which a penetration bar 16 passes through the first through hole 14 formed in the salient pole 10.

Fastening means, for example, rivets (not shown), may be formed at both ends of the penetration bar 16. In other words, the first armature module 10 and the last armature module 10 of the first member may be secured by the rivets.

In FIG. 6, a plurality of armature modules 10 are secured to the armature module base 30 by the second spacer 18 to maintain the interval between the armature modules 10 in the same armature block.

The second spacer 18 and the armature module base 30 may be secured to each other by screws or bolts.

If the second spacer 18 is secured to the armature module base 30 while the upper end of the second spacer 18 protrudes in the third direction (Y direction) above the upper end of the connection part 11 of the armature module 10, an interval may be formed between the connection part 11 of the armature module 10 and the armature module base 30.

The air flow formed by the fan 40 may proceed through the interval between the armature module 10 and the armature module base 30, thereby dissipating the heat generated in the coils 13 wound around the armature module 10.

Alternatively, the plurality of armature modules 10 may be secured to the armature module base 30 by the third spacer 19.

The first spacer 17 for maintaining the interval between two neighboring armature modules 10 may be in the shape of a cylindrical pillar with a hole in the center. Alternatively, the first spacer 17 may be a polygonal pillar with a central hole and a non-circular cross-sectional area. The penetration bar 16 may pass through the central hole.

The second spacer 18 for maintaining the interval between two neighboring armature modules 10 and securing the armature module 10 to the armature module base 30 has a rectangular parallelepiped shape elongated in the second direction (X direction). The length of the second spacer 18 in the second direction may correspond to the length of the connection part 11 of the armature module 10 in the second direction.

The second spacer 18 may be elongated in the second direction (X direction) to increase the coupling strength of the second spacer 18 and the armature module base 30 or the coupling strength between the armature module 10 and the armature module base 30.

When the second spacer 18 is viewed in the first direction while the second spacer 18 is inserted between the two armature modules 10, the upper end of the second spacer 18 may protrude further above the upper end of the connection part 11 of the armature module 10.

Since the upper end of the second spacer 18 protrudes upward further than the upper end of the connection part 11 of the armature module 10, when the second spacer 18 is secured to the armature module base 30, an interval may be formed between the armature module 10 and the armature module base 30.

Also, when the second spacer 18 is viewed in the first direction, a recessed part may be formed below the upper end of the second spacer 18 near the center based on the second direction (X direction). In other words, the second spacer 18 may have a U-shaped cross-section when viewed from the first direction and may have a rectangular cross-section when viewed from the second and third directions.

The recessed part of the second spacer 18 is formed so that the second spacer 18 and the armature module base 30 are not in close contact with each other in the second direction (X direction) in the entire section but maintain an interval in the second direction at least in some sections.

The air may flow smoothly in the first direction through the recessed part of the second spacer 18, and the air flow pressurized by the fan 40 may reach the armature module 10 located away from the fan 40.

When the second spacer 18 is viewed in the first direction, the three holes in the lower part are designed for passing the penetration bar 16 that has passed through the first through hole of the armature module 10; when the second spacer 18 is viewed in the third direction, the two holes on either side are intended for inserting screws or bolts to secure the second spacer 18 and the armature module base 30.

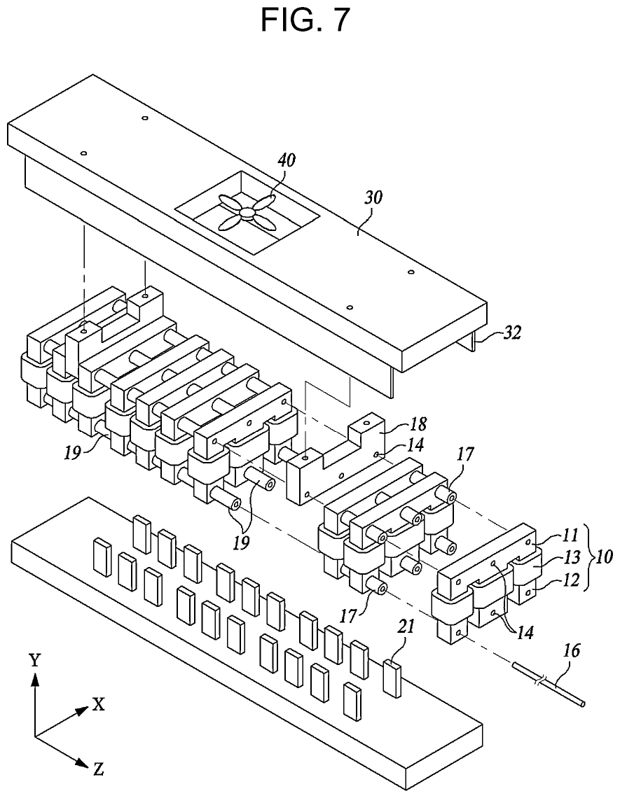

FIG. 7 illustrates an embodiment in which a windshield protrudes toward a first member from the base of the linear motor of FIG. 6.

As shown in FIG. 7, a windshield (or wall) 32 may protrude from the bottom of the armature module base 30 in a direction toward the first member or armature module 10.

As shown in FIG. 7, two windshields 32 may be formed side by side outside the salient poles 12 on both sides of the armature module 10 along the first direction (Z direction).

Alternatively, two additional windshields 32 may be formed side by side outside the first armature module 10 and the last armature module 10 of the first member along the second direction (X direction).

The windshield 32 may protrude from the armature module base 30 to a position lower than the position where the coil 13 is wound around the salient pole 12 of the armature module 10.

The windshield 32 may prevent the air generated by the pressure according to the rotation of the fan 40 from escaping to the outside of the armature module 10 near the fan 40 without being delivered to the armature module 10 far from the fan 40. In other words, the windshield 32 may allow the air generated by the fan 40 to flow throughout the entire armature module 10 constituting the first member.

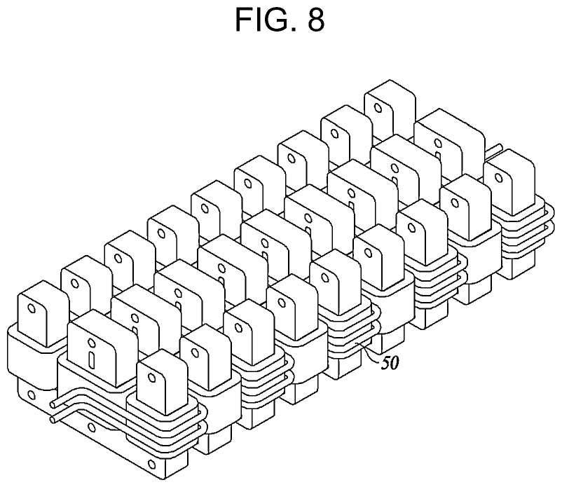

FIG. 8 illustrates an embodiment in which a conduit for refrigerant flow is installed between armature modules around which coils are wound.

As shown in FIG. 8, to cool the heat generated in the coil 13 wound around the salient pole 12 of the armature module 10, the conduit 50 for refrigerant flow may be disposed between the armature modules 10 with wound coils 13.

Heat generated in the coil 13, which carries a large current at high frequency, may be dissipated to the outside through the refrigerant flowing in the conduit 50.

The conduit 50 may be manufactured in a bent, zigzag shape and coupled to the first member in such a way that it is inserted between the armature modules 10.

Various embodiments of the linear motor of the present disclosure will be briefly and clearly described as follows.

A linear motor according to one embodiment may comprise a first member including a plurality of amature modules; and a second member including a permanent magnet module that includes a plurality of permanent magnets, of which the poles are alternated in a first direction along which the plurality of amature modules are arranged, wherein one of the first member or the second member becomes a mover, and the other becomes a stator moving relative to each other in the first direction; wherein each armature module includes a magnet core including a connection part, and two or more salient poles protruding from the connection part, and a coil carrying a current of the same phase and wound around the magnetic core; wherein the permanent magnet module is disposed between two salient poles of the amature module; and wherein a distance between two neighboring armature modules is larger than a distance between two neighboring salient poles within the same amateur module.

In one embodiment, a penetration hole may be formed in the first direction on the salient pole while being exposed.

In one embodiment, the corners of a bobbin, which is inserted into the salient pole and guides the winding of the coil, may be rounded.

In one embodiment, a linear motor may further comprise a spacer for maintaining an interval between two neighboring armature modules; and a base for securing the plurality of armature modules through the spacer, wherein an interval may be formed between the base and the connection part of the armature module by the spacer.

In one embodiment, the upper end of the spacer may protrude further than the upper end of the connection part.

In one embodiment, when the spacer that secures the armature module and the base is viewed in the first direction, a recessed part may be formed below the upper end of the spacer in the middle of the spacer based on the second direction along which the two or more salient poles are arranged.

In one embodiment, the linear motor may further comprise a fan mounted on the base.

In one embodiment, the base may include a first windshield which is formed outside further than salient poles on either side of the armature module along the first direction and protrudes toward the armature module.

In one embodiment, the base may further include a second windshield which is formed outside further than the first and last armature modules of the first member along a second direction in which the two or more salient poles are arranged and protrudes toward the armature module.

In one embodiment, the first windshield may protrude further than the position where the coil of the armature module is wound in the third direction in which the salient pole protrudes.

In one embodiment, the motor may further comprise a conduit for refrigerant flow installed between two neighboring armature modules at the position where the coil is wound.

In one embodiment, the conduit may be bent in a zigzag shape and inserted between the armature modules to be coupled to the first member.

It should be understood by those skilled in the art from the descriptions given above that various modifications and variations may be made without departing from the technical spirit or scope of the present disclosure. Therefore, the technical scope of the present disclosure is not limited to the specifications provided in the detailed descriptions of this document but has to be defined by the appended claims.

What is claimed is:

1. A linear linear motor comprising:
a first member including a plurality of amature modules; and
a second member including a permanent magnet module that includes a plurality of permanent magnets, of which the poles are alternated in a first direction along which the plurality of amature modules are arranged,
wherein one of the first member or the second member becomes a mover, and the other becomes a stator moving relative to each other in the first direction;
wherein each armature module includes a magnet core including a connection part, and two or more salient poles protruding from the connection part, and a coil carrying a current of the same phase and wound around the magnetic core;
wherein the permanent magnet module is disposed between two salient poles of the amature module; and
wherein a distance between two neighboring armature modules is larger than a distance between two neighboring salient poles within the same amateur module.

2. The linear motor of claim 1, wherein a penetration hole is formed in the first direction on the salient pole while being exposed.

3. The linear motor of claim 1, wherein corners of a bobbin, which is inserted into the salient pole and guides the winding of the coil, are rounded.

4. The linear motor of claim 1, further comprising:
a spacer for maintaining an interval between two neighboring armature modules; and
a base for securing the plurality of armature modules through the spacer,
wherein an interval is formed between the base and the connection part of the armature module by the spacer.

5. The linear motor of claim 4, wherein an upper end of the spacer protrudes further than an upper end of the connection part.

6. The linear motor of claim 5, wherein, when the spacer that secures the armature module and the base is viewed in the first direction, a recessed part is formed below the upper end of the spacer in middle of the spacer based on a second direction along which the two or more salient poles are arranged.

7. The linear motor of claim 4, further comprising a fan mounted on the base.

8. The linear motor of claim 7, wherein the base includes a first windshield which is formed outside further than salient poles on either side of the armature module along the first direction and protrudes toward the armature module.

9. The linear motor of claim 8, wherein the base further includes a second windshield which is formed outside further than a first and last armature modules of the first member along a second direction in which the two or more salient poles are arranged and protrudes toward the armature module.

10. The linear motor of claim 7, wherein the first windshield protrudes further than a position where the coil of the armature module is wound in a third direction in which the salient pole protrudes.

11. The linear motor of claim 1, further comprising a conduit for refrigerant flow installed between two neighboring armature modules at a position where the coil is wound.

12. The linear motor of claim 11, wherein the conduit is bent in a zigzag shape and inserted between the armature modules to be coupled to the first member.
